(19) United States
(12) Patent Application Publication
(10) Pub. No.: US 2026/0293878 A1
(43) Pub. Date: Oct. 1, 2026

(54) Systems and Methods for Predator Monitoring and Deterrence

(71) Applicant: FlyShepherd, Inc., Dover, DE (US)

(72) Inventor: Christopher James REDING, Reno, NV (US)

(21) Appl. No.: 19/430,178

(22) Filed: Dec. 22, 2025

Related U.S. Application Data
(60) Provisional application No. 63/780,303, filed on Mar. 30, 2025.

(51) Int. Cl. A01M 29/00; B64U 10/13; G06V 10/764; G06V 20/52

(52) U.S. Cl. CPC A01M 29/00; B64U 10/13; G06V 10/764; G06V 20/52; B64U 2201/10

(57) ABSTRACT

The various implementations described herein include methods and devices for predator deterrence. In one aspect, a system includes ground-based camera(s) in proximity to a protected area of land, a computing device configured to receive images captured by the ground-based cameras, detect predators, determine geospatial coordinates of detected predators, and generate predator alerts upon detecting a predator in the received images. The system also includes a drone system configured to receive the predator alerts and launch a drone with a target location specified by geospatial coordinates included in the corresponding predator alert. The system further includes, for each drone of the drone system, a deterrent subsystem that is capable of generating sound and light and executing tactical maneuvers, and a navigation subsystem that includes one or more cameras that determine flight paths. The deployed deterrents may be species-specific. A method of operating the predator deterrent system is also disclosed.

### RELATED APPLICATIONS

This application claims priority to U.S. Patent Application Ser. No. 63/780,303, filed Mar. 30, 2025, titled “Automated Predator Deterrent System for Livestock Protection Using Drones and Stationary Cameras,” which is incorporated by reference herein in its entirety.

### TECHNICAL FIELD

The disclosed implementations relate generally to predator deterrence and more specifically to systems and methods of using autonomous drones and smart imaging to implement predator deterrence.

### BACKGROUND

Livestock ranching is often threatened by predation from wild animals such as wolves, coyotes, and large carnivores, which can cause significant economic loss. Traditional methods of predator control often involve lethal measures or fencing, which can be expensive, ineffective, or harmful to wildlife. There is a growing need for non-lethal methods to deter predators without causing harm to the animals or the environment.

### SUMMARY

Disclosed are new systems and methods for non-lethal predator deterrent.

The disclosed methods and systems provide non-lethal predator deterrent that uses cameras for visualization and detection of predators and drones that can deploy deterrent measures to repel and drive predators away from livestock. The disclosed system and methods use real-time data analysis to detect potential threats and deploy deterrents, via drones, such as lights, sounds, or other stimuli, to scare predators away without harming the predators or the livestock. The system is also configured to identify species and execute, via a drone, species-specific deterrent profiles that coordinate audio sequences, visual stimuli, and tactical flight maneuvers to repel the predator. This autonomous coordination ensures targeted, scalable protection for livestock.

In accordance with some implementations, a predator deterrent system includes one or more ground-based cameras in proximity to a protected area of land and one or more image computing devices configured to: receive images of the protected area and/or areas adjacent to the protected area that are captured by the ground-based cameras, utilize a trained model trained on images of predators and images not containing predators to determine whether received images include images of one or more predators, determine geospatial coordinates of detected predators, and generate predator alerts upon detecting one or more predators in the received images. The system also includes a drone system that includes one or more drones configured to receive the predator alerts from the one or more image computing devices; determine drone availability; and upon determining that at least one drone is available, launch a drone with a target location specified by geospatial coordinates included in the corresponding predator alert. The system further includes a respective deterrent subsystem for each of the one or more drones. Each deterrent subsystem includes a control system, a speaker system configured to generate one or more predefined audio sequences over a range of volumes, a visual output system configured to generate bursts of lights or other visual stimuli, and memory storing instructions for one or more tactical movement maneuvers of the drone. The control system is configured to specify actions for the speaker system, the visual output system, and the tactical maneuvers of the drone. The system also includes a respective drone navigation subsystem for each drone. Each drone navigation system includes one or more drone cameras that dynamically determine flight paths for the respective drone.

In some embodiments, determining drone availability includes determining whether weather conditions are within a predefined range of wind speed and predefined range for current precipitation.

In some embodiments, determining drone availability includes determining whether there is at least one drone not currently deployed.

In some embodiments, determining drone availability includes determining whether there is at least one undeployed drone whose battery charge is above a threshold level.

In some embodiments, the predator deterrent system further includes a power system to supply electricity to the ground-based cameras, the one or more image computing devices, and the drone system.

In some embodiments, the power system includes one or more solar panels.

In some embodiments, the power system is connected to an electrical power grid.

In some embodiments, the artificial intelligence model uses a Convolutional Neural Network.

In some embodiments, each ground-based camera is associated with a respective associated image computing device, and each combination of a ground-based camera and an associated image computing device consists of an integrated camera/computing device.

In some embodiments, the one or more ground-based cameras comprise a plurality of ground-based cameras and the ground-based cameras all communicate wirelessly with a single image computing device.

In some embodiments, the single image computing device is separate from the plurality of cameras.

In some embodiments, the single image computing device is collocated with a first one of the plurality of cameras.

In some embodiments, the one or more ground-based cameras comprise a plurality of distinct types of cameras.

In some embodiments, the distinct types of cameras include visual spectrum cameras, IR cameras, thermal imaging cameras, multispectral sensors, and/or lidar.

In some embodiments, at least a first drone of the one or more drones stores a patrol route and is configured to capture images while traversing the patrol route.

In some embodiments, the first drone initiates the patrol route in response to a fixed schedule, a user request, or a predator detection event.

In some embodiments, the predator deterrent system further includes a monitoring system with a user interface dashboard.

In some embodiments, communication between ground-based cameras, image computing devices, and drone systems utilize a routing layer to dynamically select reliable network links in real-time.

In some embodiments, communication between ground-based cameras, image computing devices, and drone systems extract cropped still images of identified objects within video captured by the ground-based cameras and drone cameras.

In some embodiments, a respective drone of the one or more autonomous drones further includes a respective deterrent subsystem and one or more drone cameras that dynamically determine flight paths for the respective autonomous drone. The respective deterrent subsystem includes: a control system, a speaker system configured to generate one or more predefined audio sequences over a range of volumes, a visual output system configured to generate bursts of lights or other visual stimuli, and memory storing instructions for one or more tactical movement maneuvers of the autonomous drone. The control system specifies actions for the speaker system, the visual output system, and the tactical maneuvers of the autonomous drone.

In some embodiments, the drone is further configured to deploy one or more deterrents towards the one or more predators.

In some embodiments, the trained model is further trained to identify a species of a predator detected in the received images. The predator alert includes species of the detected one or more predators in the received images. The one or more deterrents deployed by the autonomous drone towards the one or more predators are selected based at least in part on the species of the predator as identified in the predator alert.

In some embodiments, each deterrent subsystem is further configured to discontinue deterrents when detected predators are no longer visible or beyond a predefined distance from the protected area.

In some embodiments, the one or more imaging devices store a priority queue of detected predators and determine predator priority based on proximity of the detected predators to the protected area and/or determination of physical characteristics of the detected predators.

In accordance with some implementations, a method of deterring one or more predators includes receiving one or more images from one or more cameras at a computing device and determining whether the one or more images includes one or more predators. The method also includes, in response to a determination that the one or more images includes one or more detected predators: (i) determining geospatial coordinates of a detected predator based on images of the detected predator, (ii) generating a predator alert that includes the geospatial coordinates of the detected predator, and (iii) transmitting the predator alert to a drone system that includes one or more drones. The method further includes receiving the predator alert at the drone system and in response to receiving the predator alert at the drone system: determining drone availability by the drone system and upon determining that at least one drone is available, launching a drone with a target location specified by geospatial coordinates included in the corresponding predator alert. The method also includes deploying, by a controller of the launched autonomous drone, one or more predefined deterrent measures. The one or more predefined deterrent measures include any of: outputting one or more predefined audio sequences over a range of volumes, outputting visual stimuli, and maneuvering the drone in one or more tactical patterns.

In some implementations, the method also includes selecting, by the drone, a deterrent profile corresponding to the species identified in the predator alert. The deterrent profile is selected from a plurality of deterrent profiles based at least in part on the species identified in the predator alert and the profile includes a specific combination of the one or more predefined deterrent measures that is designed to target a specific type of predator.

In some implementations, the method also includes determining, by a drone navigation subsystem for the drone, a flight path for the drone based on one or more drone cameras that are part of the drone.

In some implementations, determining whether the one or more images includes one or more predators includes: (i) providing the one or more images to a model that is trained on images of predators and images not containing predators; (ii) generating, by the trained model, an output determining whether the received images include images of one or more predators; and (iii) determining whether the one or more images include one or more detected predators based on the output.

In various circumstances, the systems and methods of the present disclosure have the following advantages over conventional predator deterrent systems. First, in accordance with some implementations, the disclosed system and methods are non-lethal and are configured not to harm predators or livestock. Second, the disclosed system and methods are trained to detect predators, identify predator species, and determine predator location thereby allowing for species-specific targeted deterrent deployment. Third, the disclosed system and methods utilize drone cameras to track the position and behavior of predators, ensuring that the deterrent system is effective in deterring predators from advancing on or attacking livestock. Fourth, the disclosed system and methods utilize specific deterrent methods and patterns that are proven to be effective in driving predators away. Fifth, the disclosed system operates autonomously without requiring manual input or oversight (e.g., leverages wireless communication to send information, utilizes autonomous drones) thereby reducing the number of human-labor hours required to monitor and keep a herd safe.

Thus, methods and systems are disclosed for predator deterrent. Such methods and systems may complement or replace conventional methods and systems of predator deterrent.

### BRIEF DESCRIPTION OF THE DRAWINGS

For a better understanding of the aforementioned systems and methods, as well as additional systems and methods that provide predator deterrence, reference should be made to the Description of Implementations below, in conjunction with the following drawings in which like reference numerals refer to corresponding parts throughout the figures.

FIG. 1A provides an example predator monitoring and deterrent system in accordance with some implementations.

FIG. 1B provides an example of a predator monitoring deterrent response to a detected predator in accordance with some implementations.

FIG. 2 is a block diagram of an example drone network in accordance with some implementations.

FIG. 3 is a block diagram of an example computing device in accordance with some implementations.

FIGS. 4A-4C provide a flowchart of a method for deterring predators in accordance with some implementations.

FIG. 5 illustrates a flowchart of an example monitoring and deterrent workflow of a predator monitoring and deterrent system in accordance with some implementations.

FIG. 6 illustrates a flowchart of an example monitoring workflow of a predator monitoring and deterrent system in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

A predator monitoring and deterrent system includes a network of one or more drones and one or more cameras to protect livestock from predators. The systems and methods are configured to detect predators in real-time using images captured by the one or more cameras and deploy the one or more drones in response to predator detection. The one or more drones are configured with deterrent actions, such as performing tactical maneuvers and/or outputting sound and/or visual stimuli (e.g., lights) that can be deployed during drone mobilization. In some implementations, the systems and methods are configured to operate autonomously and require little to no human intervention or supervision.

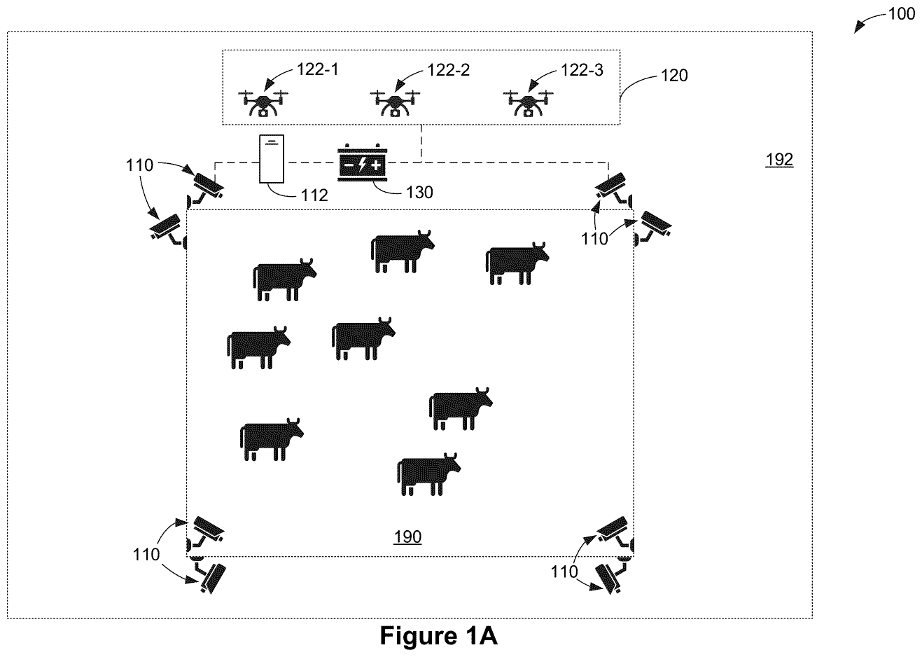

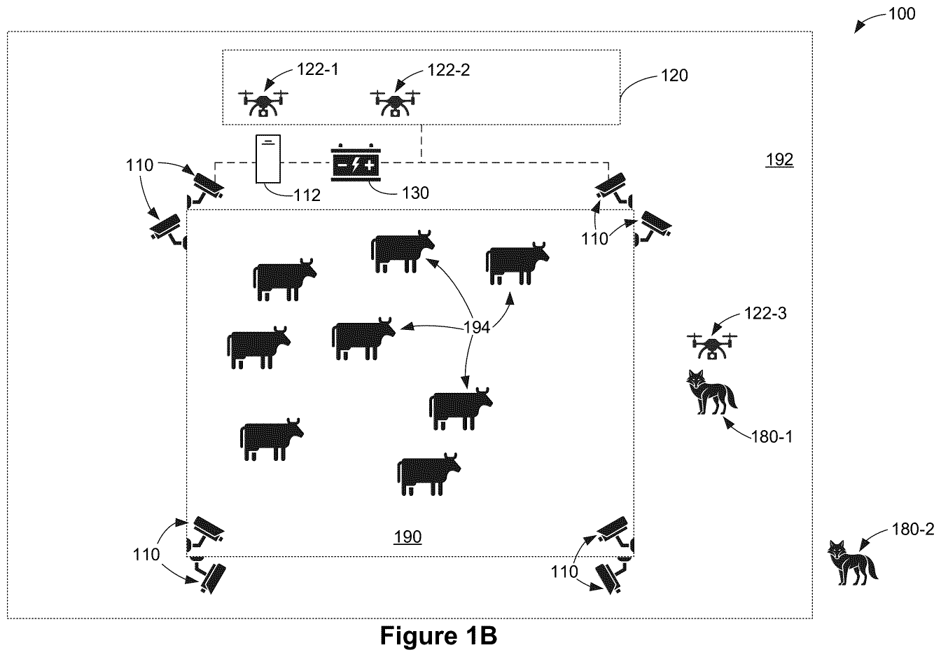

FIG. 1 provides an example predator monitoring and deterrent system 100 in accordance with some implementations. The predator monitoring and deterrent system 100 includes one or more cameras 110 (referred to collectively or singularly as camera(s) 110) that are configured to capture images and a drone network 120 (also referred to as a drone system 120) that includes one or more drones 122 (referred to collectively or singularly as drone(s) 122) that can be launched to deploy predator deterrent measures. The predator monitoring and deterrent system 100 also includes one or more image computing devices 112 (referred to collectively or singularly as image computing device(s) 112) that are configured to analyze images collected (e.g., taken, acquired) by the one or more cameras 110 and generate predator alerts based on analysis of the images. The predator monitoring and deterrent system 100 also includes a power system 130 that is configured to provide power to any of: the one or more cameras 110, the one or more image computing devices 112, and/or the drone network 120 (including the one or more drones 122).

In some embodiments, the one or more cameras 110 are configured to capture images of a specified surveillance area, such as a protected area of land 190 (e.g., livestock enclosure, farmland, grazing land) and optionally, surrounding area(s) 192 that surround or are adjacent to the protected area 190 of land. In some embodiments, the one or more cameras 110 are configured to continuously monitor or surveil the specified surveillance area for the presence of predators and/or predator activity.

In some embodiments, the one or more drones 122 are autonomous drones that can be automatically deployed by the drone system 120 without human intervention (e.g., human control, manual control, manual intervention). In such cases, the autonomous drones are capable of executing all drone functions described herein autonomously (e.g., automatically and without human intervention or control).

In some embodiments, the one or more drones 122 are configured to be deployed within an air space that corresponds to (e.g., is above) the protected area 190 and/or surrounding area(s) 192 (e.g., area(s) surrounding the protected area 190, area(s) adjacent to the protected area 190, and/or area(s) near the protected area 190). In some embodiments, the one or more drones 122 are configured to be deployed within an airspace that is larger than the protected area of land 190. In some embodiments, the one or more drones 122 are configured to be deployed within an airspace that is larger than the specified surveillance area that is monitored (e.g., surveilled) by the one or more cameras 110. For example, the cameras 110 are configured to monitor (e.g., surveil or take images of) the protected area 190 and the drones 122 are configured to be deployed within the protected area 190. In another example, the cameras 110 are configured to monitor (e.g., surveil or take images of) the protected area 190 and the drones 122 are configured to be deployed within the protected area 190 as well as the surrounding area 192.

In some embodiments, the predator monitoring and deterrent system 100 also includes a monitoring system with a user interface dashboard that allows a user (e.g., human user) to monitor and optionally, adjust operations of the predator monitoring and deterrent system 100. For example, a user may be able to select different patrol routes and or patrol routines for the drones 122. In another example, the user may select or change the protected area 190.

### Cameras

In some embodiments, the one or more cameras 110 include ground-based cameras, such as cameras that are positioned directly on the ground and ground-mounted cameras. For example, ground cameras can include cameras that are positioned directly on the ground and/or cameras that are mounted onto a structure that is in the ground, such as a camera that is mounted on a post, a fence, or on the side of a building. In some embodiments, the one or more cameras 110 include stationary cameras. Stationary cameras include cameras that are fixed in position and have a fixed field of view as well as cameras that are fixed in position and have an adjustable field of view. For example, a stationary camera may be mounted on a wooden post and is positioned to capture images of a specific area that is within the field of view of the camera. In another example, a stationary camera may be mounted on an adjustable arm or mount that allows the camera to swivel or pan to capture images from a wider area than a field of view of the camera or to change an area over which the camera is monitoring (e.g., without manual repositioning by a person). In another example, a stationary camera may have adjustable functions that allows the camera to zoom (in/out), pan (left/right/up/down, swivel), and tilt (e.g., change viewing angle). In all of these examples, the stationary camera maintains a same position (e.g., same location, same geospatial coordinates, global position system coordinates) unless manually relocated (e.g., by a human). Stationary cameras are different from mobile cameras, which may be deployed on mobile systems, such as a drone system or a vehicle.

In some embodiments, the one or more cameras 110 include mobile cameras that can move around freely without requiring manual repositioning. For example, a camera mounted on a car or drone can move around without a person physically coming into contact with the camera and physically relocating the camera).

In some embodiments, the one or more cameras 110 include a semi-stationary camera, such as a camera mounted on a dolly or cable system. In this example, the camera is mounted on a platform or system that has limited movement, such as a camera mounted on a dolly with wheels that can travel along a preset track. Thus, the semi-stationary camera has limited movement that is defined by the physical limitations of the system during set-up (e.g., the camera and dolly can only move along a track).

The one or more cameras 110 can include cameras that are capable of any of: visible light imaging (e.g., capturing images and light in the visible portion of the electromagnetic spectrum), infrared imaging (e.g., capturing images and light in the near-infrared and/or far-infrared portion of the electromagnetic spectrum), and thermal imaging (e.g., capturing images based on heat emitted or reflected from objects). For example, the one or more cameras 110 can include any of: visual spectrum cameras, IR cameras, thermal imaging cameras, multispectral sensors, and/or light detection and ranging (LIDAR) systems.

The one or more cameras 110 can include cameras that are capable of capturing still images as well as cameras that are capable of capturing video (e.g., from which images can be extracted).

### Image computing Devices

The one or more image computing devices 112 are configured to receive images captured (e.g., acquired, taken) by the one or more cameras 110 and analyze the one or more images to determine if any predators are detected in the images. The one or more image computing devices 112 are also configured to determine the location (e.g., position, geospatial coordinates) of detected predators, and to generate and transmit a predator alarm to the drone network 120 in response to a determination that one or more predators are detected in the one or more images. In some embodiments, the one or more image computing devices 112 are also configured to transmit geospatial coordinates to the drone network 120. The geospatial coordinates may be used by the drone network 120 in determining drone deployment (e.g., which drone(s) to deploy, where to deploy the drone(s), and whether any drone(s) are available to be deployed).

In some embodiments, the one or more image computing devices 112 utilize a trained model (e.g., a trained machine learning model, a trained artificial intelligence model, a trained neural network) to determine if any predators are detected in the images. In some embodiments, the trained model is trained to detect predator(s) in images. In some embodiments, the trained model is trained using training images that include images containing one or more predators and images that do not contain predators.

In some embodiments, the one or more image computing devices 112 are also configured to identify (e.g., classify) a species of the predator (e.g., Northern Spotted Owl, Western Snowy Plover, Mexican Gray Wolf, Red Wolf, Wolverine, Grizzly Bear). In some embodiments, the one or more image computing devices 112 are also configured to generate a confidence score for species identification that indicates a confidence of the system in the species identification (e.g., Red Wolf identified, confidence score=92%). In some embodiments, the one or more image computing devices 112 utilize a trained model (e.g., a trained machine learning model, a trained artificial intelligence model, a trained neural network) for species identification and, optionally, a confidence score associated with the species identification. In some embodiments, the one or more image computing devices 112 are also configured to transmit the identified predator species to the drone network 120 as part of the predator alarm. For example, in response to a determination that a predator has been detected in an image and identification that the detected predator is a red wolf, the one or more image computing devices 112 sends a predator alert to the drone network 120 that includes the geospatial coordinates of the detected predator and an indication that the detected predator is identified as a red wolf.

In some embodiments, the one or more image computing devices 112 are configured to extract cropped still images of identified objects within video captured by the one or more cameras 110.

The one or more image computing devices 112 are configured to detect predators in images captured by the one or more cameras 110 regardless of whether the predator is tagged (e.g., has been caught, tagged with small device such as a radio transmitter, a satellite tag, a passive integrated transponder, or microchip). Thus, the one or more image computing devices 112 are able to detect predators that are tagged as well as predators that are not tagged.

In some embodiments, the one or more image computing devices 112 include an edge computing device that is integrated into a camera. For example, a camera of the one or more cameras 110 may be an edge device (e.g., edge-camera, edge-capable camera) that includes an image computing device so that images acquired by the camera can be processed on-device by the camera to determine if any predators are detected in the images. In such cases, at least a first image computing device is collocated (e.g., located at the same location) as a first camera (e.g., the image computing device and the camera are part of a same device).

In some embodiments, the one or more image computing devices 112 include one central image computing device that is in communication. For example, the one or more image computing devices 112 may be able to communicate wirelessly to the one or more cameras 110 and the drone network 120. In some embodiments, the image computing device 112 is separate from the one or more cameras 110.

In some embodiments, the one or more image computing devices 112 are in communication (e.g., wired communication, wireless communication) with the one or more cameras 110 so that images captured by the one or more cameras 110 can be transmitted to and received by the one or more image computing devices 112 for processing (e.g., analysis). In some embodiments, the one or more image computing devices 112 are in communication (e.g., wired communication, wireless communication) with the drone network 120 so that the one or more image computing devices 112 can transmit predator alerts (which may or may not include geospatial coordinates of the predator(s)) to the drone network 120. In some embodiments, the predator alert includes a species identification for the detected predator. In some embodiments, the one or more image computing devices 112 are in communication (e.g., wired communication, wireless communication) with an external computer system (such as a database or another computing system) such that information collected by the deterrent system 100 can be transmitted to the external computer system. For example, information regarding predator alerts and/or images of detected predators can be transmitted to the external computer system thereby allowing a remote user (e.g., a user that is not on-site at the protected area 190 or not on-site at the location of the deterrent system 100) to view information acquired by the deterrent system 100. For example, the one or more image computing devices 112 can transmit images of detected predators and predator alerts generated based on images captured by the one or more cameras 100 in a remote grazing area in the tundra in Canada to a computer system located in Toronto so that a user located in Toronto can view the acquired information remotely.

In some embodiments, the one or more image computing devices 112 are configured to send information as compact messages over low bandwidth links (e.g., sending images that include detected predators instead of providing continuous streaming of images captured at the one or more cameras 110).

In some implementations, predator alerts generated and transmitted by the computing devices 112 are also provided to a user (e.g., supervisor, human user, manager) at a user interface (e.g., a screen or display that is in communication with the computing devices 112).

In some embodiments, the predator monitoring and deterrent system 100 is also configured to transmit an alert (e.g., to a human or organization, such as sending an email or text message to a registered email address or phone number, respectively) in response to a determination that a deterrence attempt has failed to deter one or more predators.

In some embodiments, communication between the one or more cameras 110 the one or more image computing devices 112, and the drone network 120 utilize a routing layer to dynamically select reliable network links in real-time.

In some embodiments, the one or more image computing devices 112 receive images captured by a drone 122 (e.g., via an on-board drone camera). In some embodiments, the one or more image computing devices 112 are configured to extract cropped still images of identified objects within video captured by a drone 122 (e.g., via an on-board drone camera).

In some embodiments, the one or more image computing devices 112 are configured to store (e.g., save, record) images that include detected predators, thereby improving memory and storage efficiency.

### Drone Network

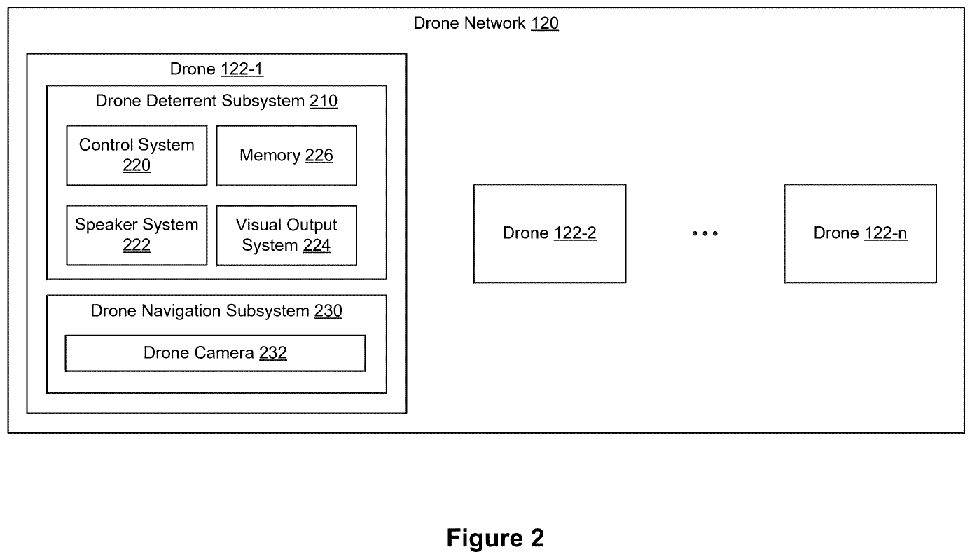

The drone network 120 includes one or more drones 122. The drone network 120 is configured to receive predator alerts (e.g., indicating that a predator has been detected) from the one or more image computing devices 112 and determine if any drones 122 are available for deployment (e.g., launching). Upon a determination that at least one drone is available, the drone network 120 launches one or more available drones to deploy deterrent measures against detected predators. In some embodiments, such as when the one or more image computing devices 112 are configured to determine geospatial coordinates of detected predators and transmit the geospatial coordinates of detected predators to the drone network 120 (e.g., either as part of or separately from transmission of the predator alert), the drone network 120 launches one or more available drones to geospatial coordinates of detected predators. Additional details regarding each drone 122 in the drone network is provided below with respect to FIG. 2.

In some embodiments, drone availability is determined based on factors such as drone battery life and drone status (e.g., broken, functional, non-functional, currently deployed, currently not deployed). In some embodiments, the drone network 120 determines drone availability based on whether or not there is at least one drone 122 that is not currently deployed. In some embodiments, the drone network 120 determines drone availability based on whether or not there is at least one drone 122 that is not currently deployed whose battery charge is above a threshold level (e.g., the undeployed drone has enough battery to reach the detected predator, deploy predator deterrent measures, and return to a drone base or charging station).

In a first example, in response to a determination that a new predator is detected, the drone network 120 may query the status of the drones 122 in the drone network 120. In response to a determination that all drones 122 are currently deployed and thus, there are no additional drones left, the drone network 120 determines that there is no drone availability to deploy (e.g., in response to detection of the new predator).

In second example, in response to a determination that a new predator is detected, the drone network 120 may query the status of the drones 122 in the drone network 120 and determine that there are at least three drones 122 that are not currently deployed and thus, possible candidates for deployment. However, upon querying the battery status of each of the undeployed drones, the drone network 120 determines that none of the available drones have enough battery to be deployed (e.g., to be effective in predator deterrent operations). Thus, the drone network 120 determines that there are no drones available for deployment.

In a third example, the drone network 120 determines that there are multiple drones 122 that are not currently deployed and that at least one of the undeployed drones has enough battery life to be deployed for performing predator deterrent operations. In some embodiments, the drone network 120 compares the battery life of an undeployed drone to a specified threshold (e.g., at least 40%, 50%, 60%, 70%, 80% battery). In some embodiments, the specific threshold is fixed. In some embodiments, the specific threshold is determined based on one or more of: a number of detected predators, a predator type, a location of the predator, a drone type (e.g., make and model), a drone weight, a drone status (e.g., drone with new battery versus drone with an old battery), and the predator deterrent capabilities of the drone.

In some embodiments, the drone(s) 122 are launched to deploy targeted deterrent maneuvers against one or more predators.

In some embodiments, the drone(s) 122 are launched to patrol the protected area 190 and/or surrounding area(s) 192. For example, a drone 122 may be configured to travel along a predefined patrol route and capture images while traversing the patrol route. In some embodiments, a patrol route is initiated in response to a fixed schedule, a user request, or a predator detection event.

In some embodiments, the drones 122 have autonomous capability and can operate with little to no human (e.g., manual) oversight (e.g., supervision, intervention, action). In some embodiments, the drones 122 can be controlled remotely (e.g., by a computer system, by a human via a remote controller).

In some embodiments, the drones 122 are capable of deploying one or more deterrents towards a predator. In some embodiments, the drones 122 are configured to deploy one or more deterrents against a predator in response to a determination that the predator is approaching or has entered a protected area. In some embodiments, the drones 122 are configured to deploy one or more deterrents against a predator in response to a determination that the predator is approaching livestock, attacking livestock, or stalking livestock. Additional details regarding the drones 122 are provided below with respect to FIG. 2.

### Power System

The predator monitoring and deterrent system 100 includes at least one power system 130 that is configured to power (e.g., provide power, provide electricity, provide electrical power) components of the predator monitoring and deterrent system 100. FIG. 1A shows an example where the power system 130 is configured to provide power for charging the drones 122 of the drone network 120, power at least some of the cameras of the one or more cameras 110, and power an image computing device 112.

The power system 130 can include type of power source, power supply, or power storage, such as a generator or battery. For example, the power system 130 includes a battery that is connected to and can be recharged by one or more renewable power sources, such as a wind turbine or solar cells. In another example, the power source can include a transformer that allows any components of the predator monitoring and deterrent system 100 to be connected to and powered by the electrical grid.

In some embodiments, the power system 130 is configured to operate in harsh and/or remote environments. In some embodiments, the power system 130 is energy efficient and weather resistant.

FIG. 1B provides an example of a predator monitoring and deterrent response to a detected predator in accordance with some implementations. In this example, the one or more cameras 110 are configured to monitor (e.g., surveil) the protected area 190 as well as a surrounding area 192 (e.g., an area that surrounds, is next to, or is near the protected area). The one or more cameras 110 capture (e.g., continuously capture, capture at time intervals) images of the protected area 190 and the surrounding area 192. The images captured by the one or more cameras 110 are analyzed by the one or more image computing devices 112 for predator detection. In this example, the one or more image computing devices 112 detect that a predator 180-1 is present in one of the images that capture the surrounding area 192. In response to a determination that a predator is detected, a predator event log is generated so that information regarding this predator event can be recorded. The one or more image computing devices 112 generate a predator alert that includes the geospatial location (e.g., a calculated position, an estimated location) of the detected predator 180-1 and transmits the predator alert to the drone network 120. In response to receiving the predator alert, the drone network 120 determines if any drones are available to be launched. In this example, drone 122-3 is available and thus, is deployed to the geospatial coordinates of the predator alert.

The predator monitoring and deterrent system 100 can perform a “monitor-only” operation or a “monitor and deter” operation.

In an example where the predator monitoring and deterrent system 100 is configured to execute a “monitor only” operation, drone 122-3 is deployed to the geospatial coordinates of the predator 180-1, and the drone 122-3 captures one or more images (e.g., images, video) of the predator 180-1. Once images of the predator 180-1 are captured by the drone 122-3, the drone 122-3 returns to the base and images of the predator 180-1 that were captured by the drone 122-3 are stored for inclusion in a logged predator event. In some embodiments, an evidence packet is generated for the logged predator event and the evidence packet includes images of the predator 180-1 captured by drone 122-3. In some embodiments, the evidence packet also includes images captured by the one or more cameras 110. In some embodiments, the evidence packet also includes metadata and other information related to the predator event, such as geospatial coordinates of predator 180-1, time stamps for the captured images, camera identification information that identifies which camera was used to capture the images, and drone pose and/or telemetry. In some implementations, the evidence packet for the logged predator event is stored (e.g., in memory of a computing device or on cloud) or transmitted to a third party (e.g., ranch owners, ranch managers, wildlife and agriculture agencies, insurers and compensation programs, and original equipment manufacturer (OEM) partners). In some embodiments, such as when the evidence packet is prepared for transmission or sharing, the evidence packet also includes integrity and delivery details for the evidence packet, such as a digital signature and/or a chain-of-custody hash.

In an example where the predator monitoring and deterrent system 100 is configured to execute a “monitor and deter” operation, the drone 122-3 travels to the geospatial coordinates of the predator 180-1 and deploys one or more predator deterrent measures to scare or drive away the predator 180-1. In some embodiments, such as when the drone 122-3 is equipped with one or more on-board drone cameras, the drone 122-3 deploys the one or more predator deterrent measures once the predator 180-1 is detected (e.g., captured, within frame) by the on-board drone camera. For example, the drone 122-3 may deploy a “bounce protocol” that targets downwash from the drones (e.g., air pushed downwards by the drone) towards a predator's face to create discomfort to and disorient the predator 180-1 and drive the predator 180-1 away from the livestock 194 (e.g., away from protected area 190) and outside of the surrounding area 192 (e.g., in a direction that is away from the protected area 190 and the livestock 194). In some embodiments, the drone 122-3 may also output loud sounds and/or strobing light as additional deterrent measures. In some embodiments, a “monitor and deter” operation includes all aspects of a “monitor-only” operation (including generating a predator log and record evidence corresponding to the predator log) and also includes drone deployment of deterrent measures. In such cases, the evidence packet may also include information regarding which deterrent measures were deployed and whether the deterrent measures were determined to be effective in deterring the predator.

FIG. 1B also shows a second predator 180-2 that is located outside of the protected area 190 and the surrounding area 192. Since the second predator 180-2 is not located within a geographical area that is being monitored (e.g., surveilled), the predator 180-2 is not detected since it is not within the field of view of any of the one or more cameras 110.

In some embodiments, the one or more drones 122 are configured to be deployed within an airspace that is smaller than a surveillance area that is monitored (e.g., surveilled) by the one or more cameras 110. For example, the one or more cameras 110 are configured to capture images of both protected area 190 and surround area 192, but the drones 122 are configured to only be deployed if a predator is detected and determined to be within the protected area 190. In this example, the one or more cameras 110 would capture images of the predator 180-1 that is in the surround area 192, but no drones 122 would be deployed until the predator 180-1 is detected in the area 190.

In some embodiments, the one or more drones comply with geofenced limits, such as no-fly boundaries that may correspond to sensitive habitats, known buildings or structures, wires, or neighboring properties.

In some embodiments, the one or more drones comply with weather condition controls that prohibit drones from being deployed in inclement weather. For example, if precipitation or icing limits exceed a predefined threshold, the drones will not be deployed until conditions improve and precipitation and icing limits fall within the predefined threshold. In some embodiments, when drones are prevented from being deployed due to weather conditions, any predator alerts are stored in a queue for future drone deployment once weather conditions improve.

In some embodiments, the drone network 120 determines how many drones 122 launch based on a number of detected predators. For example, the drone network 120 may be configured to launch as many available drones as there are detected predators (e.g., when 5 drones are available and 4 predators are detected, the drone network 120 will launch 4 drones).

In some embodiments, such as when there are fewer available drones than there are detected predators, the drone network 120 is configured to prioritize drone deployment to geospatial coordinates of predators based on proximity to the protected area 190 and/or proximity to livestock. For example, if two predators are detected but only one drone is available, the drone network 120 will deploy the one available drone to geospatial coordinates of the predator that is closer to the protected area 190. In another example, if two predators are detected but only one drone is available, the drone network 120 will deploy the one available drone to geospatial coordinates of the predator that is closer to livestock.

In some embodiments, a priority queue of detected predators is stored in the one or more image computing devices 112 or in memory that is part of the drone network 120. In some embodiments, the priority queue of detected predators is used to determine predator priority based on proximity of the detected predators to the protected area and/or determination of physical characteristics of the detected predators. In some embodiments, the drones 122 of the drone network 120 are deployed in order based on the priority queue. In some embodiments, the priority queue is dynamically updated based on the most recently determined geospatial coordinates of detected predators.

FIG. 2 is a block diagram of an example drone network 120 in accordance with some implementations. The drone network 120 includes one or more drones 122. In this example, the drone network 120 includes n number of drones.

Each drone 122 of the drone network includes a drone deterrent subsystem 210 that includes a control system 220, a speaker system 222, a visual output system 224, memory 226. The speaker system 222 is configured to output audio (e.g., sounds). In some embodiments, the speaker system 222 is capable of outputting sounds at multiple volumes (e.g., varying volumes, different volumes, over a range of volumes). The visual output system 224 is configured to output visual stimuli, such as emitting light. In some embodiments, the visual output system 224 is capable of outputting light at multiple colors (e.g., wavelengths) and/or multiple brightnesses.

In some embodiments, the deterrent subsystem 210 is configured to discontinue deterrents when detected predators are no longer visible or beyond a predefined distance from the protected area 190 and/or surrounding area(s) 192. Thus, deterrent measures are only deployed when a predator is in or near the protected area 190 and/or surrounding area(s) 192. This can lead to a negative reinforcement for predators associated with the protected area 190 and/or surrounding area(s) 192 (e.g., a pasture) and deter predators away from approaching the protected area 190 and/or surrounding area(s) 192 in the future.

In some embodiments, the memory 226 stores predator deterrent measures, including one or more tactical maneuvers (also referred to as tactical measures) that specify a specific sequence of actions for the drone to implement (e.g., a specific sequence of lights, sounds, or drone movements). For example, a tactical maneuver may include a specific sequence to output seven bursts of light while outputting audio of a honking car at 60 decibels.

In another example, a tactical maneuver can include emitting audio corresponding to predator specific distress calls (e.g., wolf sounds that indicate that a wolf is in distress). In yet another example, tactical maneuver can include audio to simulate the presence of humans (e.g., sounds humans yelling or gun shots).

In yet another example, the tactical maneuver can include specific aircraft motions or movements, such as deploying the drone 122 to perform a controlled downwash “bounce,” optionally, in addition to other deterrent measures such as output of sounds and/or lights.

In some embodiments, the drone 122 selects which tactical maneuver(s) to deploy (or not deploy) based on the species identification (when provided as part of the predator alert). For example, if the predator is identified as being a protected species, the drone 122 may decide not to deploy any deterrent measures to comply with law enforcement policies and wildlife rules. In another example, if the predator is identified as a bird of prey (that can fly and can attack livestock from above), the drone 122 may select tactical maneuvers that are able to target animals that are effective on flying animals. In yet another example, if the predator is identified as a non-flight-capable predator such as a Gray Wolf, the drone 122 may select tactical maneuvers that include drone movements close to the ground to effectively deter a Gray Wolf.

In some embodiments, the drone 122 selects a deterrent profile based on the predator species as identified in the predator alert. The deterrent profile includes a set of deterrent measures that are targeted towards a specific type of predator. For example, some deterrent measures may be effective on flight-based predators (e.g., birds of prey) but not effective against ground predators.

For example, the predator alert indicates that the detected predator is a wolf and the drone 122 selects a deterrent profile for ground predators that hunt in packs. The drone 122 executes deterrent measures as indicated in the profile, such as flying 20-40 meters from the wolves, then maneuvering to a position that is 2 to 3 meters above the lead wolf of the pack. The drone 122 then executes a vertical bounce pattern (e.g., rapidly moving up and down) directly above the lead wolf so that the rotor downwash from the drone 122 is directed at the lead wolf's head and shoulders. The drone 122 also outputs loud randomized sounds of humans shouting while flashing white strobing lights downwards towards the wolves.

In another example, the predator alert indicates that the detected predator is a bear and the drone 122 selects a deterrent profile for large ground predators or stimulus tolerant predators. The drone 122 executes deterrent measures as indicated in the profile, such as maintaining a horizontal stand-off distance of 30-60 meters from the predator and flying at a higher altitude compared to profiles that correspond to smaller predators. The drone 122 then executes herding or circling flight patterns to push the bear away from livestock, giving the bear a clear route away from the livestock to escape the drone's movements. The drone 122 also outputs light at a high intensity with a lower strobing frequency compared to the lights output when deploying deterrent measures for pack predators. The drone 122 also outputs audio of humans shouting at a high volume.

In another example, the predator alert indicates that the detected predator is a mountain lion and the drone 122 selects a deterrent profile for ambush predators. The drone 122 executes deterrent measures as indicated in the profile, such as deploying searchlight style lights toward the mountain lion and flies at a close distance to the mountain lion in order to deter the stalking behavior. The deterrent profile for ambush predators may not, for example, include a downwash “bounce” action since it is less effective at ambush predators than pack predators.

In some embodiments, such as when the predator alert indicates a low confidence in the identified species or indicates that a non-target species (e.g., non-predator species) has been detected (e.g., deer), the drone 122 selects a low-level deterrent profile that includes outputting lights from a high altitude to deter the deer and avoid unnecessary disturbance.

In some embodiments, the tactical maneuvers are tiered such that a drone 122 is configured to deploy a low tiered tactical maneuver before escalating to a higher tiered tactical maneuver. For example, a drone 122 may deploy Tier 1 tactical maneuvers that include specific aircraft movements configured to direct the predator 180 away from livestock. In response to a determination that the predator 180 remains undeterred, the drone 122 may deploy Tier 2 tactical maneuvers which include outputting strobing lights at the predator 180.

In some embodiments, the drone 122 selects which tactical maneuvers to deploy based on the distance between the predator and the protected area 190. For example, the drone 122 may deploy low-level deterrents such as lights from a high altitude when predators are more than 300 meters away from the protected area 190 but escalate to outputting bright strobing lights at the predator's face when the predator is less than 20 meters from the protected area.

In some embodiments, the drone 122 selects which tactical maneuvers to deploy based on the distance between the predator and livestock. For example, the drone 122 may deploy bright strobing lights at the predator's face and output loud sounds to temporarily dazzle and disorient a predator that is actively attacking livestock.

In some embodiments, the drone 122 selects which tactical maneuvers to deploy based on the terrain. For example, if the terrain is a forest that includes a high density of tall trees, the drone 122 may select tactical maneuvers that are effective from high altitudes if the drone 122 cannot safely and effectively navigate below the canopy of the trees.

In some embodiments, emission of light-based deterrents from the drone 122 are randomized.

In some embodiments, emission of sound-based deterrents from the drone 122 are randomized. For example, the drone 122 may output randomized sounds of humans shouting as a deterrent measure.

In some embodiments, the one or more tactical maneuvers include non-lethal measures. In some embodiments, the one or more tactical maneuvers do not include lethal measures. In some embodiments, the drones 122 are not equipped to execute lethal maneuvers.

In some embodiments, the memory 226 also stores one or more patrol routes. In some embodiments, the one or more patrol routes are part of a patrol routine that is coordinated between multiple drones of the drone network.

In some embodiments, the memory 226 also stores images captured by the drone during a patrol routine (e.g., while traversing a patrol route, while on patrol, while patrolling).

The control system 220 is configured to control (e.g., specify, send signals to implement) actions for the speaker system 222, the visual output system 224, and other controls of the drone (e.g., mechanical controls that control flight and/or movement of the drone). For example, the control system 220 can control the drone 122 and its subsystems and modules to deploy deterrent measures, such as deploying a tactical maneuver (e.g., a set of predefined actions) that includes a specified drone movement in combination with outputting predefined audio at a prespecified volume.

Each drone 122 of the drone network also includes a drone navigation subsystem 230 that includes one or more drone cameras 232. The drone navigation subsystem 230 determines flight paths for the drone 122. In some embodiments, the drone navigation subsystem 230 utilizes the one or more drone cameras 232 to determine or update in real time, flight paths for the drone 122. For example, in response to determining that the drone 122 is approaching a heavily wooded area, the drone navigation subsystem 230 may update the flight path to stop and surveil or to increase altitude so that the drone 122 does not crash into any trees. In another example, the drone navigation subsystem 230 may utilize the one or more drone cameras 232 to track movement of a predator and plot a flight path to follow the detected predator (until it has left the protected area 190 or is far enough from the protected area 192).

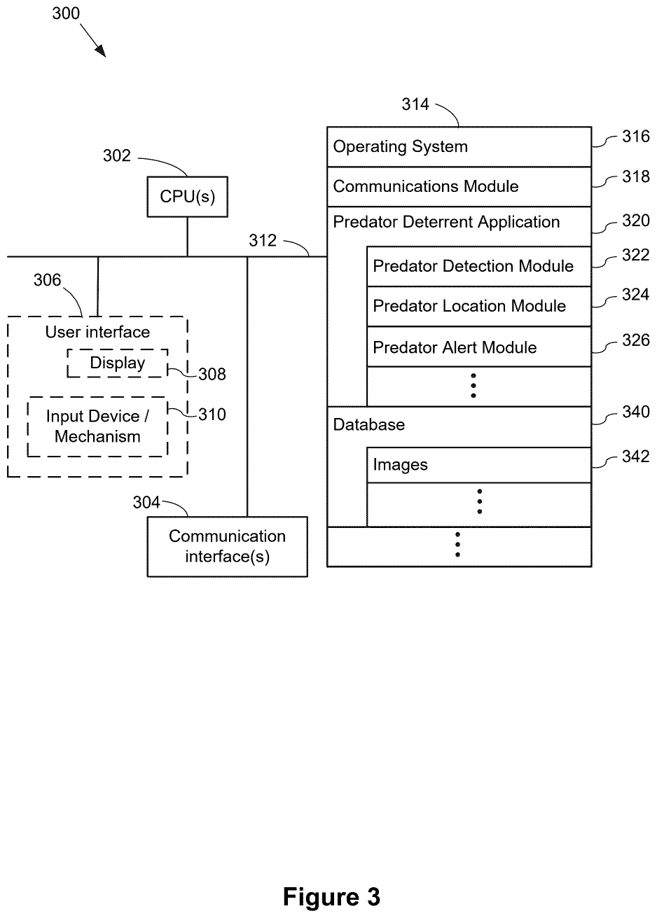

FIG. 3 is a block diagram of a computing device 300 in accordance with some implementations. Various examples of the computing device 300 include a desktop computer, a laptop computer, a tablet computer, and other computing devices (e.g., IT or OT devices) that have a processor capable of running a predator deterrent application 320. The computing device 300 typically includes one or more processing units/cores (e.g., computer processing unit(s), graphical processing unit(s)) 302 for executing modules, programs, and/or instructions stored in the memory 314 and thereby performing processing operations; one or more network or other communications interfaces 304; memory 314; and one or more communication buses 312 for interconnecting these components. The communication buses 312 may include circuitry that interconnects and controls communications between system components.

The computing device 300 optionally includes a user interface 306 comprising a display device 308 and one or more input devices or mechanisms 310. In some implementations, the input device/mechanism includes a keyboard. In some implementations, the input device/mechanism includes a “soft” keyboard, which is displayed as needed on the display device 308, enabling a user to “press keys” that appear on the display 308. In some implementations, the display 308 and input device/mechanism 310 comprise a touch screen display (also called a touch sensitive display).

In some implementations, the memory 314 includes high-speed random-access memory, such as DRAM, SRAM, DDR RAM or other random-access solid-state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the processing core(s) 302. The memory 314, or alternatively the non-volatile memory devices within the memory 314, comprises a non-transitory computer-readable storage medium. In some implementations, the memory 314, or the computer-readable storage medium of the memory 314, stores the following programs, modules, and data structures, or a subset thereof:
an operating system 316, which includes procedures for handling various basic system services and for performing hardware dependent tasks;
a communications module 318, which is used for connecting the computing device 300 to other computers and devices via the one or more communication network interfaces 304 (wired or wireless) and one or more communication networks, such as the Internet, other wide area networks, local area networks, metropolitan area networks, and so on;
a predator deterrent application 320, configured to detect the presence of predators in images and generate alerts (e.g., warnings) in response to detected predators. The predator deterrent application 320 includes one or more of:
   a predator detection module 322, which is configured to detect the presence of predators in images, such as images captured by the one or more cameras 110). In some embodiments, the predator detection module 322 includes a trained model (such as a machine learning model, an artificial intelligence model, or a neural network) that is configured to detect (e.g., determine) whether or not predators are present in an image. For example, the predator detection module 322 may utilize a trained model that is trained using training images (e.g., tagged images used for training the model) that include images with predators and images without predators. For example, the trained model may be a convolutional neural network;
   a predator location module 324, which is configured to determine a location or position of detected predators. For example, predator location module 324 may be able to determine geospatial coordinates of a detected predator based on the position of the detected predator in the image in combination with information regarding the camera that captured the image (e.g., a location of the camera, an orientation of the camera, technical specifications of the camera); and
   a predator alert module 326, which is configured to generate a predator alert (e.g., warning) when a predator is detected in the images. In some embodiments, a predator alert includes a position or location of the predator (e.g., geospatial coordinates of the detected predator) as determined by the predator location module 324; and
   one or more databases 340, which are used by the predator detection module 322. The one or more databases 340 may include images 342 (including video that is composed of a series of images) that are analyzed by the predator deterrent application 320. For example, the one or more databases 340 may include images 342 that are captured by the one or more cameras 110. The images 342 may be stored for review, as part of data collection, and/or for inclusion as training images for training new models for predator deterrent-related applications (such as predator detection, predator location detection, predator identification). The images 342 may be stored as part of evidence packets corresponding to logged predator events.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above (e.g., the predator deterrent application 320 does not include the predator alert module 326). Furthermore, the memory 314 may store additional modules or data structures not described above (e.g., the predator deterrent application 320 further includes a species identification module).

Although FIG. 3 shows a computing device 300, FIG. 3 is intended more as a functional description of the various features that may be present rather than as a structural schematic of the implementations described herein. In practice, and as recognized by those of ordinary skill in the art, items shown separately could be combined and some items could be separated.

In some embodiments, the computing device 300 is an edge computing device that is integrated into a camera. In some embodiments, at least some of the modules of predator deterrent application 320, such as the predator detection module 322 is implemented by a trained model, which can include any of a digital trained model, and analog circuit implementing the trained model, or hybrid trained model where at least a first portion of the trained model is implemented by an analog circuit and at least a second portion of the trained model is implemented by a digital model.

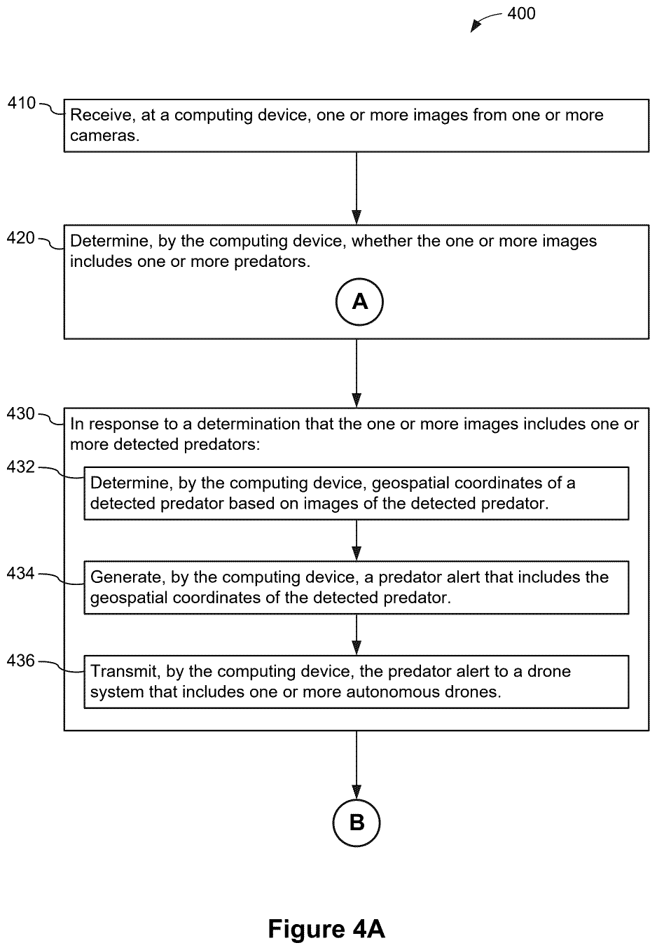

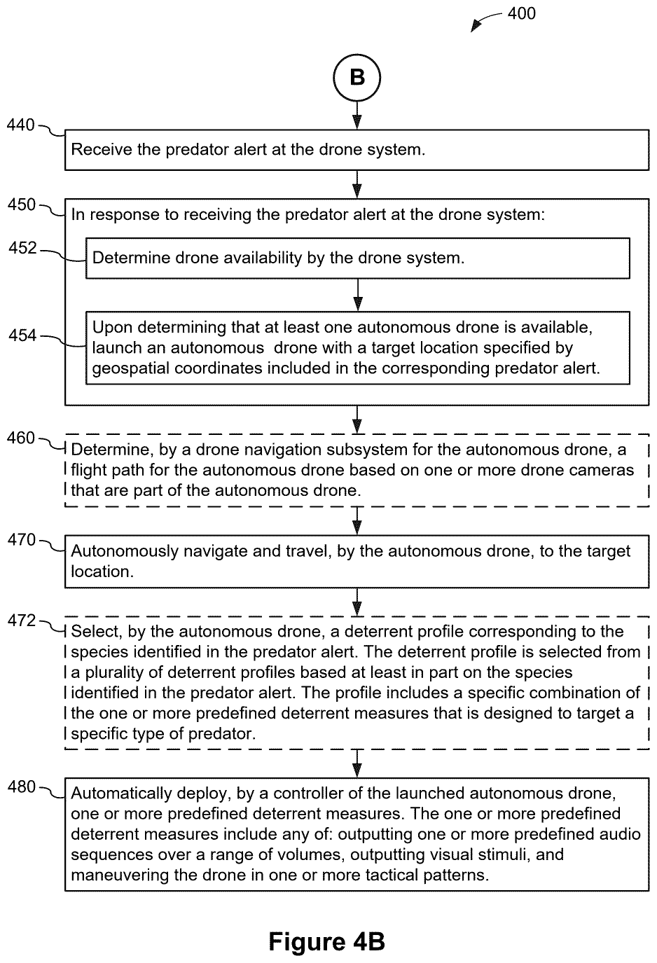

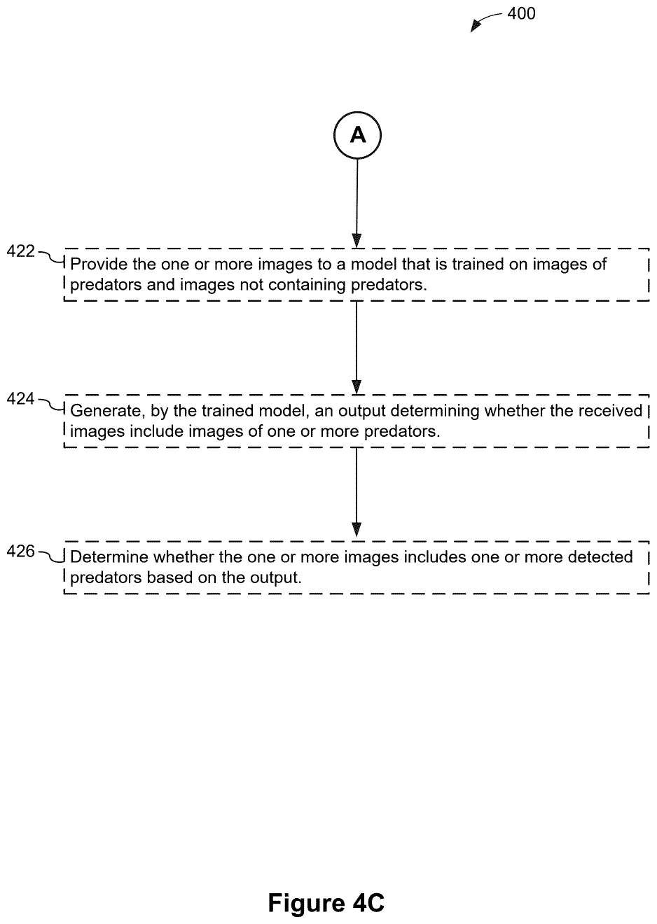

FIGS. 4A-4C provide a flowchart of a method 400 for deterring predators in accordance with some implementations. The method 400 is performed by a predator monitoring and deterrent system (e.g., predator monitoring and deterrent system 100 shown in FIG. 1A). The method 400 includes receiving (step 410) one or more images from one or more cameras 110) at a computing device (e.g., image computing device 112, computing device 300) and determining (step 420), by the computing device, whether the one or more images includes one or more predators (such as predators 180-1 and/or 180-2, shown in FIG. 1B). The method 400 also includes, in response (step 430) to a determination that the one or more images includes one or more detected predators: (i) determining (step 432), by the computing device, geospatial coordinates of a detected predator (e.g., predator 180-1) based on images of the detected predator; (ii) generating (step 434), by the computing device, a predator alert that includes the geospatial coordinates of the detected predator 180-1; and (iii) transmitting (step 436), by the computing device, the predator alert to a drone system 120 that includes one or more autonomous drones 122. The method 400 also includes receiving (step 440) the predator alert at the drone system 120, and in response (step 450) to receiving the predator alert at the drone system 120: determining (step 452) drone availability by the drone system and upon determining that at least one drone is available, launching (step 454) an autonomous drone 122 with a target location specified by geospatial coordinates included in the corresponding predator alert. The method 400 further includes autonomously navigating and traveling (step 470), by the autonomous drone, to the target location; and automatically deploying (step 480), by a controller of the launched autonomous drone, one or more predefined deterrent measures. The one or more predefined deterrent measures include any of: outputting one or more predefined audio sequences over a range of volumes, outputting visual stimuli, and maneuvering the drone in one or more tactical patterns.

In some implementations, the method 400 also includes determining (step 460), by a drone navigation subsystem 230 for the autonomous drone 122, a flight path for the autonomous drone 122 based on one or more drone cameras 232 that are part of the autonomous drone 122.

In some implementations, determining (step 420) whether the one or more images includes one or more predators includes providing (step 422) the one or more images to a model that is trained on images of predators and images not containing predators; generating (step 424), by the trained model, an output determining whether the received images include images of one or more predators; and determining (step 426) whether the one or more images includes one or more detected predators based on the output.

In some implementations, the method 400 further includes selecting (step 472), by the autonomous drone, a deterrent profile corresponding to the species identified in the predator alert. The deterrent profile is selected from a plurality of deterrent profiles based at least in part on the species identified in the predator alert. The profile includes a specific combination of the one or more predefined deterrent measures that is designed to target a specific type of predator

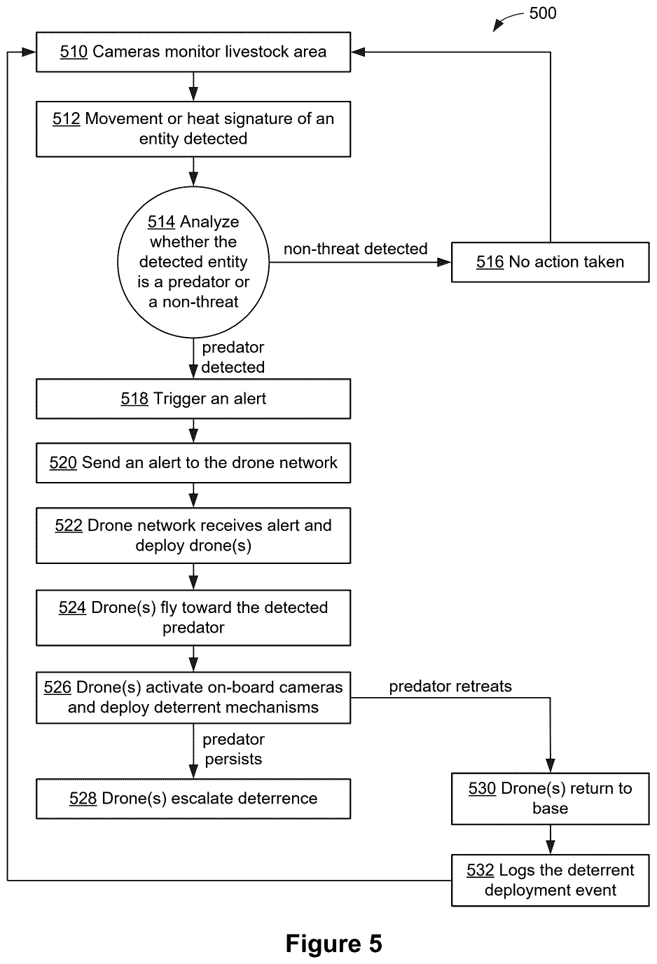

FIG. 5 illustrates a flowchart of an example predator monitoring and deterrent workflow 500 of a predator monitoring and deterrent system 100 in accordance with some implementations. In step 510, the one or more cameras 110 monitor a livestock area (such as protected area 190). In step 512, the one or more image computing devices 112 determine that movement or a heat signature of an entity is detected in the one or more images captured by the one or more cameras. In step 514, the images are analyzed (e.g., by the one or more image computing devices 112, computing devices 300) to determine whether or not the detected entity is a predator (e.g., a predator, such as a wolf, or a non-predator or a non-threat). In response to a determination (e.g., by the one or more image computing devices 112, computing devices 300) that the detected entity is a non-threat, such as a human or livestock, no further actions are taken (step 516) and the one or more cameras 110 continue monitoring the livestock area (step 510). In response to a determination that the detected entity is a threat, such as a wolf, an alert is triggered in step 518 and a predator alert is sent to the drone network 120 (e.g., by the one or more image computing devices 112, computing devices 300) in step 520. In some implementations, the images are also analyzed (e.g., by the one or more image computing devices 112, computing devices 300) to determine what type of species of predator is present in the images. In some implementations, such as when a predator species is identified, the predator alert also includes information identifying the species of the predator. In step 522, the drone network 120 receives the predator alert and deploys drone(s) 122 and in step 524, the drone(s) 122 fly toward the detected predator (e.g., toward geospatial coordinates of the detected predator, as determined by the one or more image computing devices 112 and transmitted to the drone network 120). In step 526 drone(s) 122 arrive at the predator location (e.g., location of predator 180-1), activate drone camera(s) 232 (e.g., on-board drone vision systems, on-board drone imaging systems), and deploy deterrent mechanisms targeted towards the predator(s). For example, the drone(s) 122 may activate drone camera(s) 232 (e.g., on-board drone vision systems, on-board drone imaging systems) when the drone(s) are a prespecified distance from the geospatial location of the predator as provided in the predator alert (e.g., 200 meters from the predator location, 100 yards from the predator location) to confirm the predator identification and location. Once the predator identification and location are confirmed, the drone(s) begin to deploy deterrent mechanisms against the predator 180. In some implementations, such as when the predator alert identifies a species of the predator 180, the drone(s) 122 deploy one or more predator deterrent measures that are selected based on the species of the predator 180.

In response to a determination (e.g., by the drone 122 or by the one or more cameras 110) that the predator is retreating, the drone(s) 122 return to a charging base in step 530. In response to a determination (e.g., by the drone 122 or by the one or more cameras 110) that the predator persists (e.g., continues towards livestock or a protected area, continues pursuing livestock, does not retreat from livestock or the protected area), the drone(s) 122 escalate deterrence mechanisms in step 528. The drone(s) 122 continue to deploy escalated deterrence mechanisms until the predator 180-1 is successfully deterred or the drone battery drops below a threshold, causing the drone(s) 122 return to the base in step 530. The deterrent deployment event is logged in step 532, and the one or more cameras 110 continue monitoring the livestock area (step 510).

In some implementations, the predator deterrent workflow 500 can be thought of as having a detection phase (steps 510-518), a communication phase (steps 520 and 522), a deterrence phase (steps 524-530), and a system reset and data collection phase (steps 530 and 532).

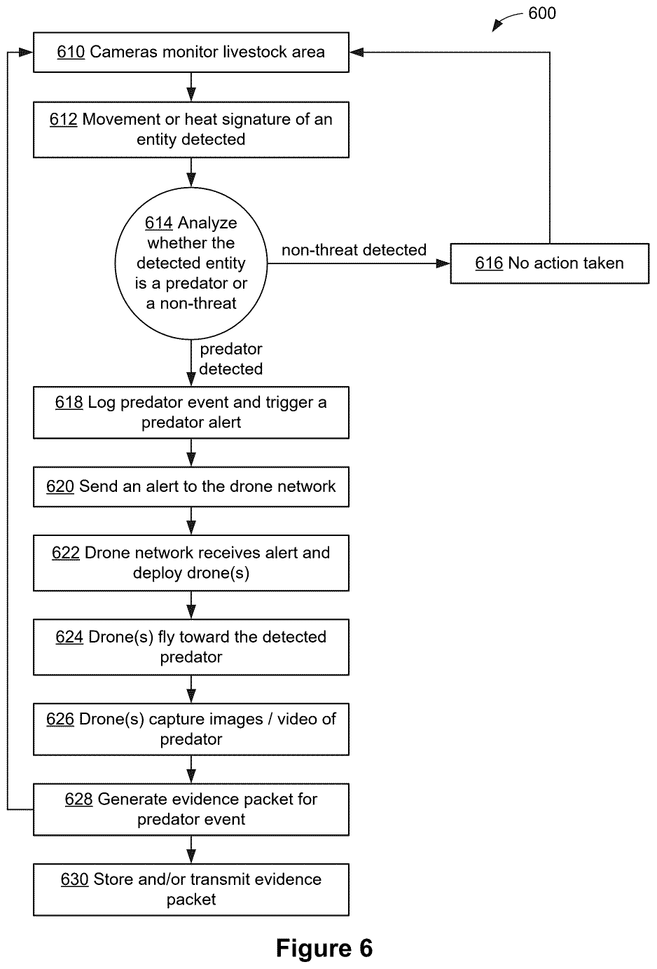

FIG. 6 illustrates a flowchart of an example predator monitoring workflow 600 of a predator monitoring and deterrent system 100 in accordance with some implementations. The predator monitoring workflow 600 is similar to the predator monitoring and deterrent workflow 500 shown in FIG. 5, except that no deterrent measures are deployed by the drone system. Steps 610-616 of the monitoring workflow 600 correspond to steps 510-516 of the predator monitoring and deterrent workflow 500 described above with respect to FIG. 5 and thus, are not repeated here for brevity.

In response to a determination that the entity detected in step 616 is a threat (such as a wolf), a predator event is logged and an alert is triggered in step 618. A predator alert is sent to the drone network 120 (e.g., by the one or more image computing devices 112, computing devices 300) in step 620. In step 622, the drone network 120 receives the predator alert and deploys drone(s) 122 and in step 624, the drone(s) 122 fly toward the detected predator (e.g., toward geospatial coordinates of the detected predator, as determined by the one or more image computing devices 112 and transmitted to the drone network 120). In step 626 drone(s) 122 arrive at the predator location (e.g., location of predator 180-1) and capture image(s) of the predator(s). The drone images are stored and included as part of an evidence packet for the logged predator event. In some implementations, image(s) of the predator(s) captured by the drone(s) is transmitted to a computer system (such as the one or more image computing devices 112, a computer system 300, or any computer system or cloud computing network that is in communication with the one or more image computing devices 112 and the drone system). In step 628, a computing system (such as the one or more image computing devices 112, a computer system 300, or any computer system or cloud computing network that is in communication with the one or more image computing devices 112 and the drone system) generates an evidence packet for the logged predator event. The evidence packet includes the image(s) of the predator(s) captured by the drone(s) 122 and may also (e.g., optionally) include images of the predator(s) captured by the one or more cameras 110. The evidence packet may also include geospatial coordinates (e.g., GPS coordinates) of the predator(s) and/or timestamps for the predator event. In some embodiments, generating the evidence packet includes encrypting the evidence packet so that it can be securely transmitted. In step 630, the computer system can store the evidence packet (e.g., in memory of the computer system or in a cloud), and/or transmit the evidence packet. For example, the evidence packet may be transmitted or shared (e.g., with any of: ranch owners, ranch managers, wildlife and agriculture agencies, insurers and compensation programs, and original equipment manufacturer (OEM) partners). Once image(s) of the predator(s) are captured, the drone(s) 122 return to the base (e.g., for charging). The one or more cameras 110 continue monitoring the livestock area (step 610).

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

1. A predator deterrent system, comprising:
one or more ground-based cameras in proximity to a protected area of land;
one or more image computing devices configured to:
receive images, of the protected area of land and/or areas adjacent to the protected area of land, captured by the ground-based cameras;
utilize a trained model to determine whether the received images include images of one or more predators, wherein the trained model is trained on images of predators and images not containing predators;
determine geospatial coordinates of detected predators; and
generate predator alerts upon detecting one or more predators in the received images; and
a drone system comprising one or more autonomous drones configured to:
receive the predator alerts from the one or more image computing devices;
determine drone availability; and
upon determining that at least one autonomous drone is available, automatically launch an autonomous drone with a target location specified by geospatial coordinates included in the corresponding predator alert for autonomous navigation and travel, by the autonomous drone, to the target location, wherein:
a first autonomous drone of the one or more autonomous drones further comprises a deterrent subsystem comprising:
a control system;
a speaker system configured to generate one or more predefined audio sequences over a range of volumes;
a visual output system configured to generate bursts of lights or other visual stimuli;
memory storing instructions for one or more tactical movement maneuvers of the first autonomous drone, wherein the control system specifies actions for the speaker system, the visual output system, and the tactical maneuvers of the first autonomous drone; and
one or more drone cameras that dynamically determine flight paths for the first autonomous drone.

2. The predator deterrent system of claim 1, wherein determining drone availability includes determining whether weather conditions are within a predefined range of wind speed and predefined range for current precipitation.

3. The predator deterrent system of claim 1, wherein determining drone availability includes determining whether there is at least one drone not currently deployed.

4. The predator deterrent system of claim 1, wherein determining drone availability includes determining whether there is at least one undeployed drone whose battery charge is above a threshold level.

5. The predator deterrent system of claim 1, wherein:
each ground-based camera is associated with a respective associated image computing device; and
each combination of a ground-based camera and an associated image computing device consists of an integrated camera/computing device.

6. The predator deterrent system of claim 1, wherein:
the one or more ground-based cameras comprise a plurality of ground-based cameras; and
the one or more ground-based cameras all communicate wirelessly with a single image computing device.

7. The predator deterrent system of claim 1, wherein the one or more ground-based cameras comprise a plurality of distinct types of cameras.

8. (canceled)

9. The predator deterrent system of claim 21, wherein the first autonomous drone automatically initiates the patrol route in response to a fixed schedule, a user request, or a predator detection event.

10. The predator deterrent system of claim 1, wherein communication between the one or more ground-based cameras, the one or more image computing devices, and the drone system utilizes a routing layer to dynamically select reliable network links in real-time.

11. The predator deterrent system of claim 1, wherein communication between the one or more ground-based cameras, the one or more image computing devices, and the drone system extract cropped still images of identified objects within video captured by the ground-based cameras and drone cameras.

12. (canceled)

13. The predator deterrent system of claim 1, wherein the autonomous drone is further configured to deploy one or more deterrents towards the one or more predators.

14. The predator deterrent system of claim 13, wherein:
the trained model is further trained to identify a species of a predator detected in the received images;
the predator alert includes species of the detected one or more predators in the received images; and
the one or more deterrents deployed by the autonomous drone towards the one or more predators are selected based at least in part on the species of the predator as identified in the predator alert.

15. The predator deterrent system of claim 13, wherein the respective deterrent subsystem is further configured to discontinue deterrents when detected predators are no longer visible or beyond a predefined distance from the protected area.

16. The predator deterrent system of claim 1, wherein the one or more imaging devices store a priority queue of detected predators and determine predator priority based on proximity of the detected predators to the protected area of land and/or determination of physical characteristics of the detected predators.

17. A method of deterring one or more predators, comprising:
receiving, at a computing device, one or more images from one or more cameras;
determining, by the computing device, whether the one or more images includes one or more predators;
in response to a determination that the one or more images includes one or more detected predators:
determining, by the computing device, geospatial coordinates of a detected predator based on images of the detected predator;
generating, by the computing device, a predator alert that includes the geospatial coordinates of the detected predator; and
transmitting, by the computing device, the predator alert to a drone system that includes one or more autonomous drones;
receiving the predator alert at the drone system;
in response to receiving the predator alert at the drone system:
determining, by the drone system, drone availability; and
upon determining that at least one autonomous drone is available, launching an autonomous drone with a target location specified by geospatial coordinates included in the corresponding predator alert;
autonomously navigating and traveling, by the autonomous drone, to the target location;
selecting, by the autonomous drone, a deterrent profile corresponding to the species identified in the predator alert, wherein:
the deterrent profile is selected from a plurality of deterrent profiles based at least in part on the species identified in the predator alert; and
the profile includes a specific combination of one or more predefined deterrent measures that is designed to target a specific type of predator; and
automatically deploying, by a controller of the launched autonomous drone, the one or more predefined deterrent measures in the selected deterrent profile, wherein the one or more predefined deterrent measures include outputting one or more predefined audio sequences over a range of volumes, outputting visual stimuli, [and] and/or maneuvering the drone in one or more tactical patterns.

18. (canceled)

19. A method of deterring one or more predators, comprising:
receiving, at a computing device, one or more images from one or more cameras;
determining, by the computing device, whether the one or more images includes one or more predators;
in response to a determination that the one or more images includes one or more detected predators:
determining, by the computing device, geospatial coordinates of a detected predator based on images of the detected predator;
generating, by the computing device, a predator alert that includes the geospatial coordinates of the detected predator; and
transmitting, by the computing device, the predator alert to a drone system that includes one or more autonomous drones;
receiving the predator alert at the drone system;
in response to receiving the predator alert at the drone system:
determining, by the drone system, drone availability; and
upon determining that at least one autonomous drone is available, launching an autonomous drone with a target location specified by geospatial coordinates included in the corresponding predator alert;
autonomously navigating and traveling, by the autonomous drone, to the target location, including determining, by a drone navigation subsystem for the autonomous drone, a flight path for the autonomous drone based on one or more drone cameras that are part of the autonomous drone; and
automatically deploying, by a controller of the launched autonomous drone, one or more predefined deterrent measures, wherein the one or more predefined deterrent measures include outputting one or more predefined audio sequences over a range of volumes, outputting visual stimuli, and/or maneuvering the drone in one or more tactical patterns.

20. The method of claim 17, wherein determining whether the one or more images includes one or more predators includes:
providing the one or more images to a model that is trained on images of predators and images not containing predators;
generating, by the trained model, an output determining whether the received images include images of one or more predators; and
determining whether the one or more images includes one or more detected predators based on the output.

21. A predator deterrent system, comprising:
one or more ground-based cameras in proximity to a protected area of land;
one or more image computing devices configured to:
receive images, of the protected area of land and/or areas adjacent to the protected area of land, captured by the ground-based cameras;
utilize a trained model to determine whether the received images include images of one or more predators, wherein the trained model is trained on images of predators and images not containing predators;
determine geospatial coordinates of detected predators; and
generate predator alerts upon detecting one or more predators in the received images; and
a drone system comprising one or more autonomous drones configured to:
receive the predator alerts from the one or more image computing devices;
determine drone availability; and
upon determining that at least one autonomous drone is available, automatically launch an autonomous drone with a target location specified by geospatial coordinates included in the corresponding predator alert for autonomous navigation and travel, by the autonomous drone, to the target location, wherein at least a first autonomous drone of the one or more autonomous drones stores a patrol route and is configured to automatically capture images while autonomously traversing the patrol route.
